(19) United States
(12) Patent Application Publication
(10) Pub. No.: US 2018/0022263 A1
(43) Pub. Date: Jan. 25, 2018

(54) LOGISTICS BRACKET FOR USE IN SECURING AND DECKING FREIGHT

(71) Applicant: Richard Meyers, Mississauga (CA)

(72) Inventor: Richard Meyers, Mississauga (CA)

(21) Appl. No.: 15/651,103

(22) Filed: Jul. 17, 2017

Related U.S. Application Data
(60) Provisional application No. 62/365,061, filed on Jul. 21, 2016.

(51) Int. Cl. B60P 7/15; A47B 57/40

(52) U.S. Cl. CPC B60P 7/15; A47B 57/404; B61D 45/006

(57) ABSTRACT

A bracket for releasably securing a logistics bar within a trailer or containment vessel to help prevent shifting of freight during transport. The bracket comprises an elongate body having two or more hangers. The hangers are releasably securable to walls of the trailer or containment vessel to hang the bracket from one of the walls. The body has one or more slots therein that releasably receive an end of a logistics bar to permit the logistics bar to be releasably secured to the bracket. The bracket is securable at different locations along the wall of the trailer or containment vessel thereby permitting the positioning of the logistics bar within the trailer or containment vessel at a desired location.

### FIELD

This invention relates generally to the field of the shipment of freight, and in particular to a logistics bracket for use in helping to secure freight during shipment. In one embodiment the invention relates to a logistics bracket that presents the ability to stack or deck freight without that freight coming into contact with freight below.

### BACKGROUND

Many of the products of today's world are shipped as freight by trucks, rail or ship. In many cases, freight is loaded into trailers or containment vessels that are then hauled by trucks, locomotives, or ships. In the case of trucks, the “trailer” may be the box of the truck itself or it may be a trailer that is towed by the truck. In the case of freight moved by ship, large, rigid and enclosed containers are commonly filled with goods and then loaded onto ships for transport from location to location. Where freight is transported by rail, the freight may be loaded into containers similar or the same as those used for shipping by water or, alternatively, freight may be loaded directly into boxcars for transport.

Regardless of the particular mode of transport, the goods in question are often loaded or secured on pallets, in boxes, in drums, or through use of a variety of other forms of packaging or shipping means. Such packaging or shipping means are then stacked or otherwise loaded into the trailer or containment vessel. In many cases, when loaded into the larger vessel, the freight does not completely fill the space available, permitting the freight to potentially shift and cause damage to itself and/or its shipping container during transport.

To help secure freight in place, others have proposed the use of logistics bars that typically extend horizontally across a larger shipping container or trailer, and that can be hooked or otherwise affixed to pre-determined and designated positions along the sidewalls of the container. Although such logistics bars can provide a certain degree of security to prevent the shifting of freight during transport, since they are limited to being positioned only at designated locations that are dictated according to the construction of the trailer or containment vessel, in many instances they still permit a degree of shifting or movement of freight.

FIGS. 1 and 2 demonstrate the use of logistics bars in a typical trailer hauled by a transport truck. In the example shown, the trailer is constructed using a series of vertically oriented studs that have their inner faces exposed. The studs include a series of slots permitting a logistics bar to be engaged within the slots of studs on opposite sides of the trailer. This permits the logistics bar to be secured in a generally horizontal orientation across the width of the trailer, and at a particular location along the length of the trailer. As shown, in many instances the location of the studs will not exactly match the outer limits of the stacked freight, thereby permitting the freight to shift during transport.

### SUMMARY

In one embodiment the invention provides a bracket for releasably securing a logistics bar within a trailer or containment vessel, the logistics bar helping to prevent shifting of freight during transport, the bracket comprising an elongate body having two or more hangers secured thereto, said hangers releasably securable to walls of the trailer or containment vessel to thereby hang said bracket from a wall of the trailer or containment vessel, said body having one or more slots therein, said slots releasably receiving an end of a logistics bar to permit the logistics bar to be releasably securable to said bracket, said bracket securable to said wall at different locations along the wall of the trailer or containment vessel thereby permitting the positioning of the logistics bar within the trailer or containment vessel at a desired location.

In another embodiment, the invention concerns a bracket for releasably securing a logistics bar within a trailer or containment vessel, the logistics bar helping to prevent shifting of freight during transport, the bracket comprising an elongate body having a front surface, a rear surface, an upper surface and a lower surface, said upper and lower surfaces extending rearwardly from said rear surface, each of said upper and lower surfaces having an inwardly oriented longitudinal lip or edge extending substantially along the length of said elongate body, said lips, said respective upper and lower surfaces and said rear surface together forming upper and lower channels extending substantially along the length of said longitudinal body; and two or more hangers secured to said elongate body, at least one of said hangers slidably received within said upper and said lower channels securing said at least one hanger to said elongate body while permitting the position of said at least one hanger to be adjusted along the length of said elongate body, said hangers releasably securable to walls of the trailer or containment vessel to thereby hang said bracket from a wall of the trailer or containment vessel, said body having one or more slots therein, said slots releasably receiving an end of a logistics bar to permit the logistics bar to be releasably securable to said bracket, said bracket securable to said wall at different locations along the wall of the trailer or containment vessel thereby permitting the positioning of the logistics bar within the trailer or containment vessel at a desired location.

In a further embodiment, the invention provides a system to assist in releasably securing a logistics bar within a trailer or containment vessel, the system comprising a plurality of the said brackets, wherein at least a first bracket is releasably securable to a wall of the trailer or containment vessel and at least a second bracket is releasably securable to an opposite wall of the trailer or containment vessel, thereby permitting one end of the logistics bar to be releasably secured to each of said brackets to releasably mount the logistics bar between the walls, and at a desired height and at a desired location along the length, of the trailer or containment vessel.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a schematic side cut away view of a transport truck and trailer, partially loaded with freight and demonstrating the use of logistics bars in accordance with the prior art.

FIG. 2 is a plan view of FIG. 1.

FIG. 3 is an upper perspective view of a prior art logistics bar.

FIG. 4 is a side view of the logistics bar shown in FIG. 3.

FIG. 5 is a side schematic cross-sectional view of a transport truck trailer demonstrating the use of the logistics bracket in accordance with an embodiment of the present invention.

FIG. 6 is a partial plan view of FIG. 5.

FIG. 7 is a schematic upper side perspective cut away view of the trailer shown in FIGS. 5 and 6, demonstrating use of an embodiment of the present invention.

FIG. 8 is an enlarged interior side view of a wall of a trailer having secured to it multiple horizontally orientated logistics brackets in accordance with an embodiment of the present invention.

FIG. 9 is a schematic side view of an interior all of a trailer having secured to it a vertically oriented logistics bracket of the present invention.

FIG. 10 is a view similar to FIG. 9 depicting the use of multiple logistics brackets in accordance with an embodiment of the invention, wherein the brackets are oriented in both a vertical and a horizontal configuration.

FIG. 11 is a front perspective view of an embodiment of a logistics bracket in accordance with the present invention.

FIG. 12 is a rear perspective view of the bracket shown in FIG. 11.

FIG. 13 is a rear view of the bracket shown in FIG. 11.

FIG. 14 is an end view of the bracket shown in FIG. 11.

FIG. 15 is a plan view of the bracket shown in FIG. 11.

FIG. 16 is a schematic view showing, in a horizontal section, a segment of the wall of a trailer prior to securing thereto of a logistics bracket in accordance with an embodiment of the invention.

FIG. 17 is a schematic vertical sectional view taken along the line 17-17 of FIG. 16 depicting the insertion of a logistics bracket, in accordance with an embodiment of the present invention, into a slot within a stud upon the trailer wall.

FIG. 18 is a view subsequent to that shown in FIG. 17 wherein the hanger of the logistics bracket has been fully received within the stud.

FIG. 19 is a view subsequent to that of FIG. 18 wherein the hanger of the logistics bar has been fully received and secured within the stud upon the trailer wall.

FIG. 20 is a rear view of a logistics bracket in accordance with an alternate embodiment of the invention, the logistics bracket having a sliding hanger.

FIG. 21 is a side view of the sliding hanger shown in FIG. 20.

FIG. 22 is a side view of a logistics bracket in accordance with an embodiment of the invention for vertical orientation.

FIG. 23 is a rear view of the bracket shown in FIG. 22.

FIG. 24 is a rear view of a variation of the bracket shown in FIG. 23 containing sliding hangers.

FIG. 25 is a side view of one of he sliding hangers shown in FIG. 24.

FIG. 26 is an upper front perspective view of the sliding hanger shown in FIG. 25.

### DESCRIPTION

The present invention may be embodied in a number of different forms. The specification and drawings that follow describe and disclose some of the specific forms of the invention.

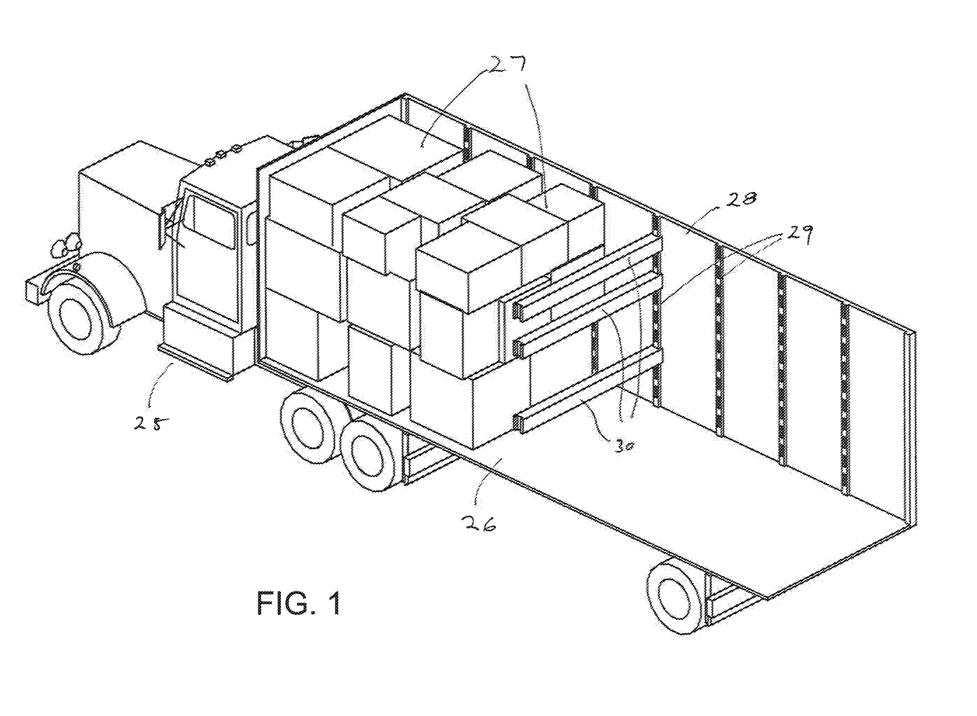

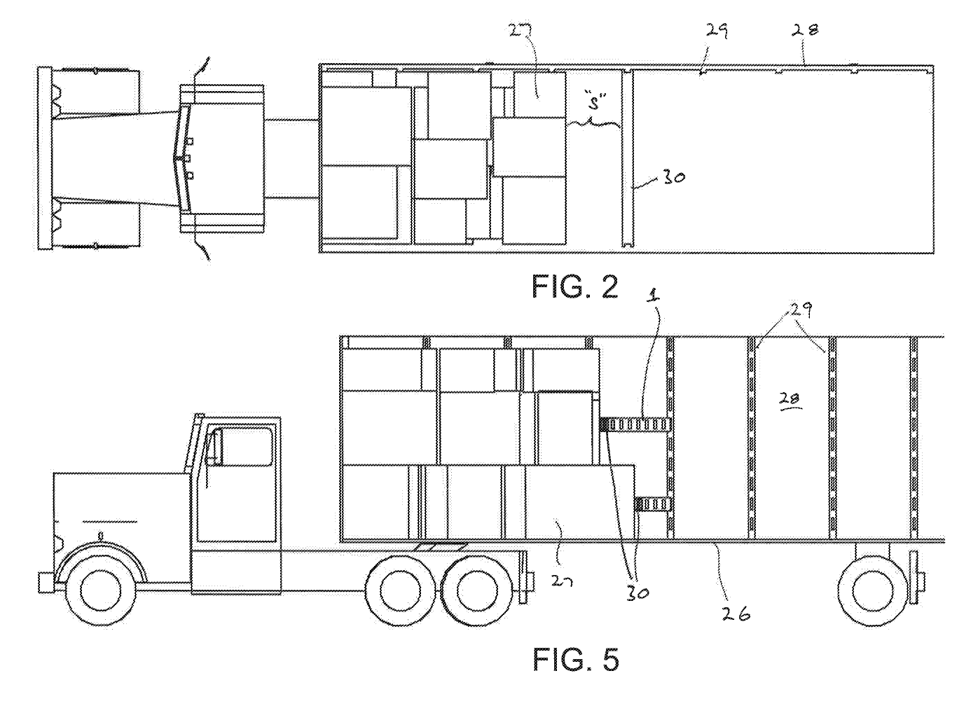

With reference to the attached Figures, FIGS. 1 and 2 show a generic transport truck 25 including a trailer 26 having loaded therein freight 27. Trailer 26 includes walls 28 having thereon studs 29 into which logistics bars 30 are received in an attempt to secure freight 27 in place, and in accordance with known practices. As demonstrated, the spacing of studs 29 is such that logistics bars 30 often do not directly contact freight 27, permitting the freight to potentially shift during transport. Here, the set-off between logistics bar 30 and freight 27 is represented by distance “s”.

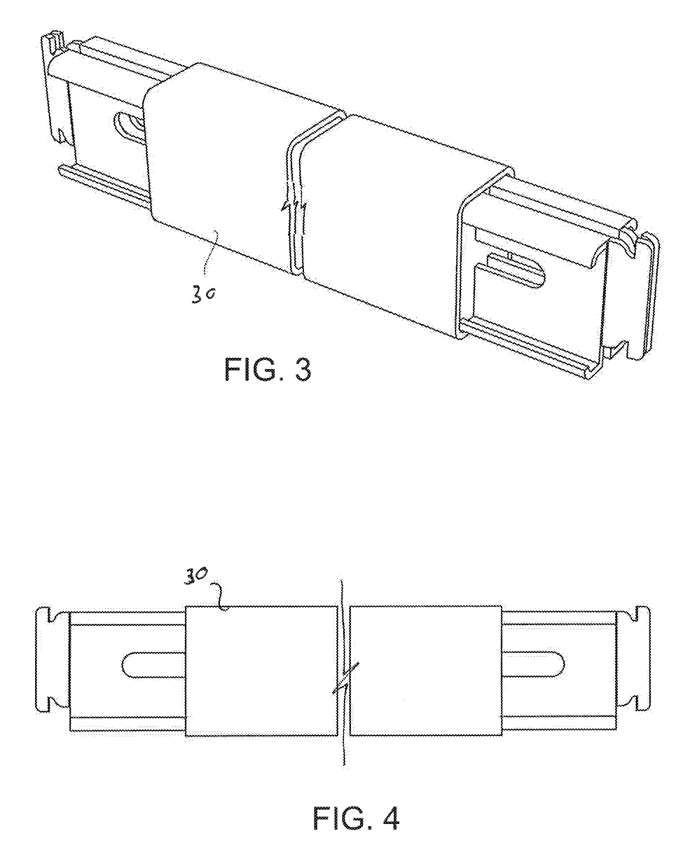

FIGS. 3 and 4 depict a generic logistics bar 30.

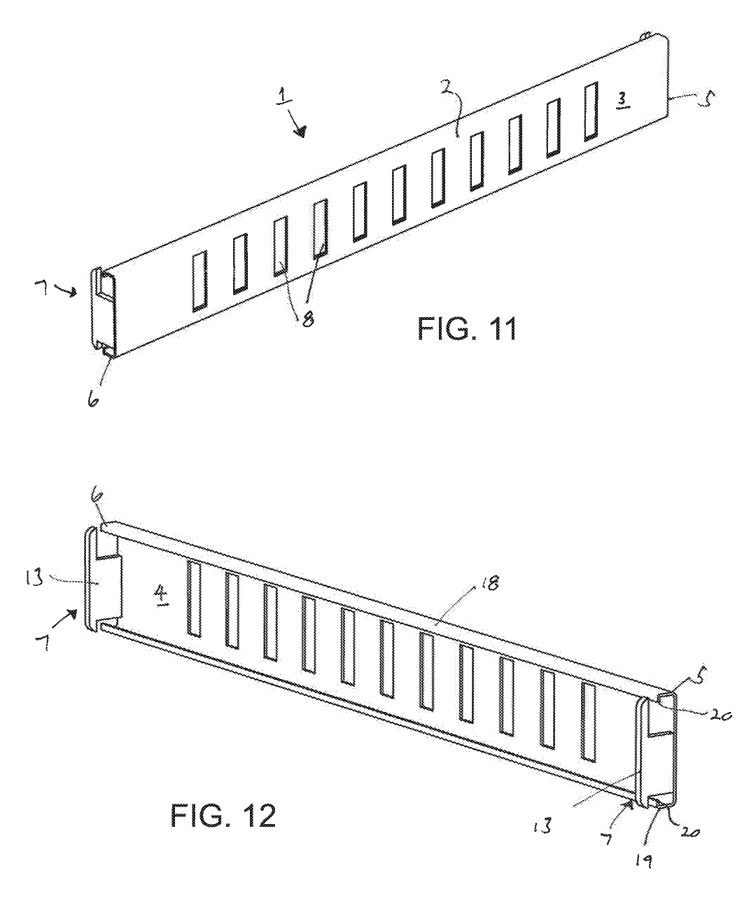

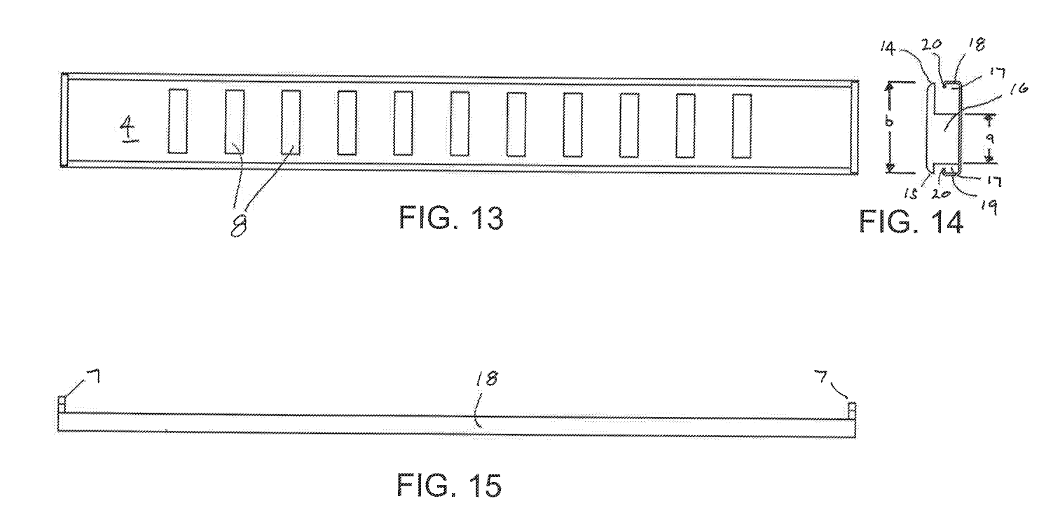

In FIGS. 11 through 15 there is shown an exemplary embodiment of a logistics bracket 1 constructed in accordance with an embodiment of the invention. In this embodiment bracket 1 is comprised generally of an elongate body 2 having a front surface 3, a rear surface 4, and two ends 5 and 6. Elongate body 2 has secured to it two or more hangers 7 that, in FIGS. 12 through 15, are positioned at ends 5 and 6. As will become more apparent following a review of the discussion below, hangers 7 are releasably securable to the walls 28 of a trailer or a containment vessel to thereby effectively hang bracket 1 from a wall of the trailer or containment vessel.

In the embodiment of the invention shown in FIGS. 12 through 15, elongate body 2 includes one or more slots 8 therein, where the slots present an opening extending from front surface 3 to rear surface 4. Preferably, there are a series of slots 8 generally equally spaced along the length of elongate body 2. Individual slots are preferably generally rectangular in configuration with their longitudinal axes generally perpendicular to the longitudinal axis of elongate body 2. As will also be appreciated from a review of the discussion below, slots 8 are designed of a size and configuration such that they permit the releasable securing of an end of a logistics bar therein, to allow an end of the logistics bar to be releasably securable to bracket 1.

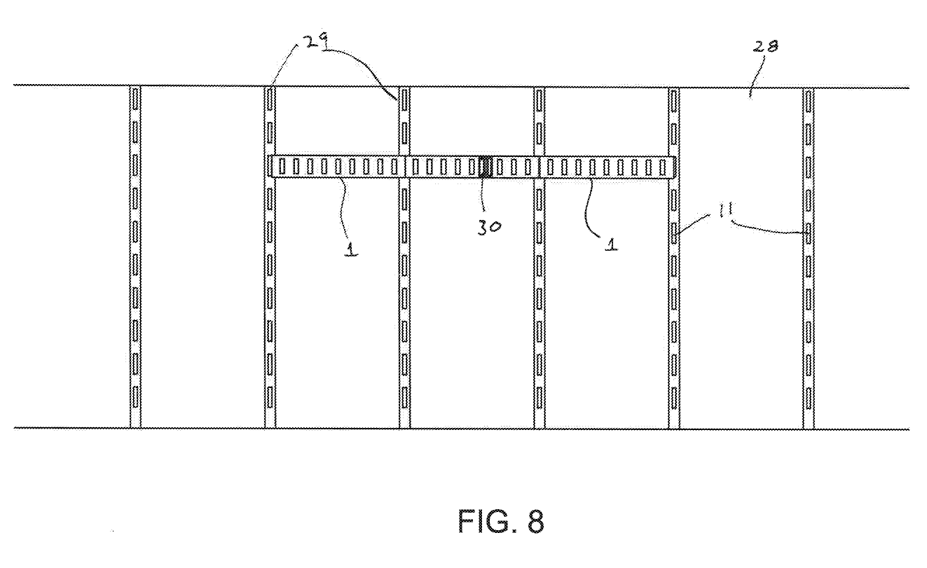

In the particular embodiment shown in FIGS. 12 through 15, elongate body 2 includes two hangers 7. Here, hangers 7 are fixed a pre-determined distance apart, where that distance approximates the centre-to-centre spacing of studs 29 within the wall 28 of a trailer or containment vessel (see FIG. 8). In many instances the walls of trailers or containment vessels contain studs 29 having within them a series of generally vertically oriented slots 11 into which logistics bars are currently received to be secured laterally across the width of the trailer or containment vessel. The spacing of hanger 7 at a distance approximating the centre-to-centre spacing of the studs within the walls of a trailer or containment vessel thus permits the hangers to be received within slots 11 in order for bracket 1 to be releasably secured between two adjacent studs. In addition, in the particular embodiment shown, hangers 11 are positioned at approximate right angles to the longitudinal axis of elongate body 2 so that when bracket 1 is releasably secured to the studs of a trailer or containment vessel, the bracket is in a generally horizontal orientation. In alternate embodiments, bracket 1 may be configured such that it spans three or more studs or, alternatively, the bracket could extend between two studs and have one or both of its ends cantilevered outwardly beyond each stud, in which case hangers 7 would be positioned at a location interior to ends 5 and 6.

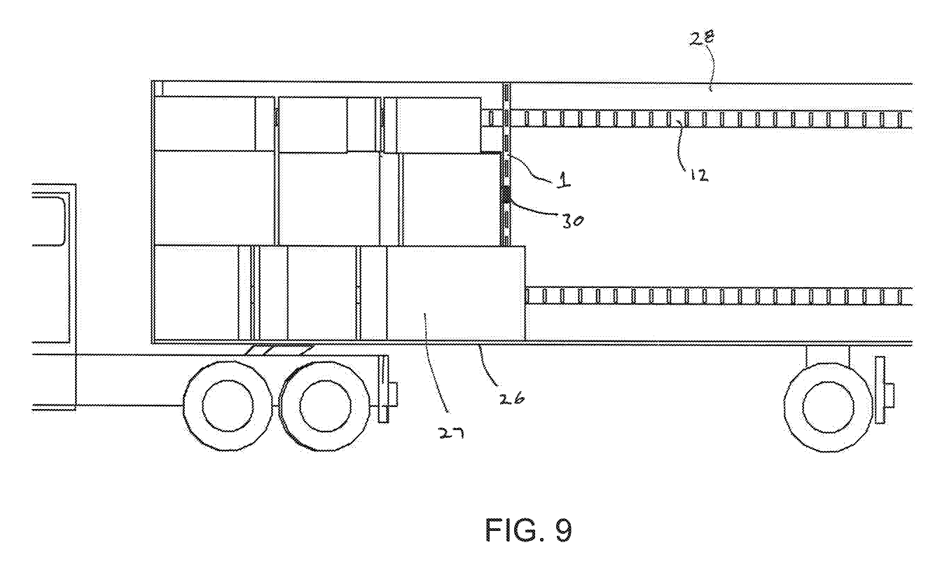

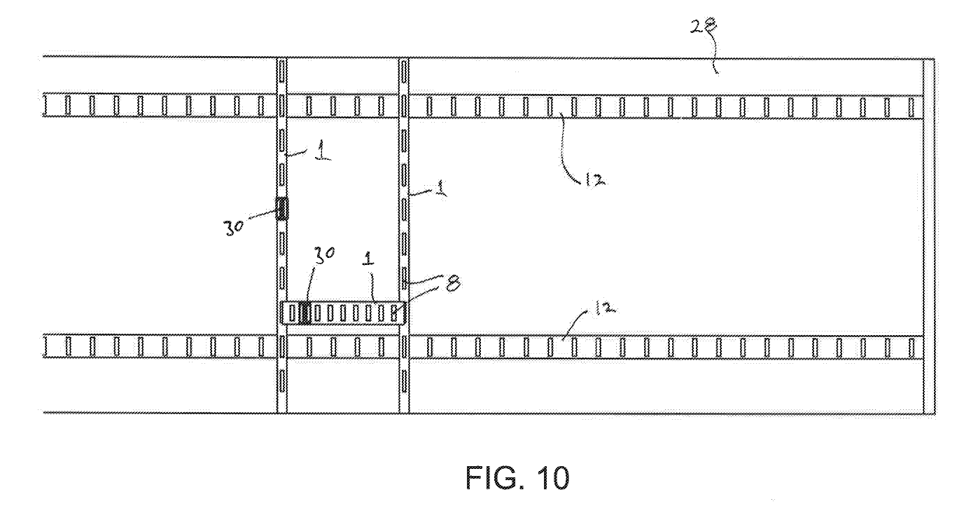

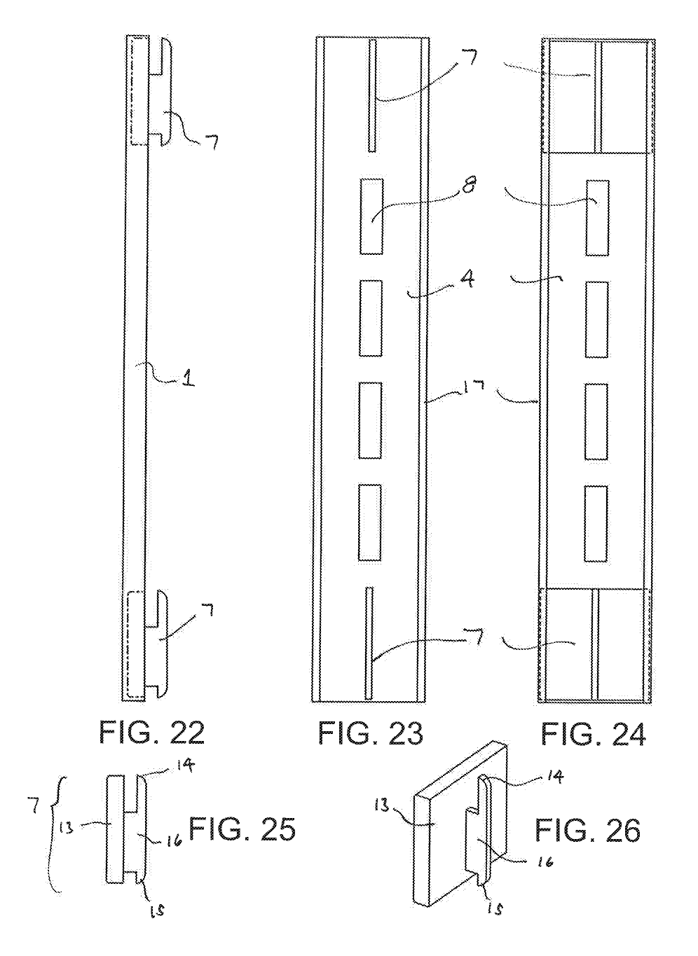

An alternate embodiment of elongate body 2 is shown in FIGS. 22 through 24. Here, bracket 1 is designed for general vertical orientation. As a result, slots 8 are oriented with their longitudinal axes generally parallel to the longitudinal axis of elongate body 2. Further, hangers 7 are in this particular embodiment fixed or otherwise secured to elongate body 2 in a configuration where the hangers are generally parallel to the longitudinal axis of elongate body 2. The application of bracket 1 constructed in such a manner to permit vertical orientation is generally applicable to trailers or containment vessels that do not have exposed studs, but instead are fitted with parallel rows of slotted track 12 that extend generally horizontally along the length of the trailer or containment vessel (as shown in FIGS. 9 and 10). In such instances the embodiment of bracket 1 shown in FIGS. 22 through 24 may be releasably secured to one or more of the parallel rows of slotted track 12 to thereby permit the bracket to be secured and hung from the wall of the trailer or containment vessel. Although not specifically shown in the drawings, it will be appreciated that in situations where slotted studs are exposed, one or more horizontally oriented brackets may be secured to two or more adjacent studs, with a vertically oriented logistics bracket releasably secured to the one or more horizontal brackets. In a similar fashion two or more vertically oriented logistics brackets may be secured to existing slotted track on the wall of the trailer or containment vessel, with one or more horizontally oriented logistics brackets then releasably secured to the two or more vertically oriented brackets (for example, see FIG. 10).

Where bracket 1 is designed for horizontal orientation, hangers 7 may comprise plates 13 that extend outwardly from rear surface 4 of elongate body 2. Plates 13 are arranged generally perpendicular to both rear surface 4 and the longitudinal axis of elongate body 2. Each of plates 13 s in turn comprised of an upper flange 14, a lower flange 15, and a connecting web portion 16. Flanges 14 and 15 extend outwardly, and in opposite directions, from web portion 16 in a plane perpendicular to the longitudinal axis of elongate body 2. As will be described in more detail below, flanges 14 and 15 are releasably receivable within slots in studs 29, in slotted track 12, or (in the case where both vertically and horizontally oriented brackets 1 are utilized) within slots 8 of another logistics bracket 1.

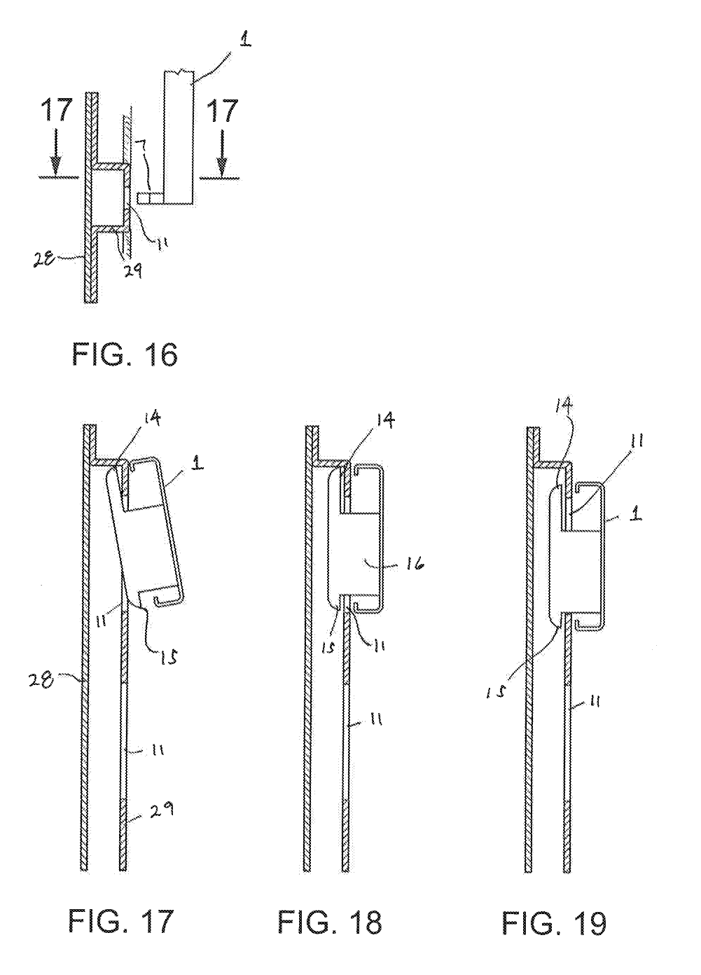

With reference to FIGS. 14 through 19, the manner in which hanger 7 of one embodiment of the invention may releasably secure bracket 1 to a stud 29 or slotted track 12 will be described in further detail. It is first important to note that the distance between the ends of flanges 14 and 15 (shown as “a” in FIG. 14) is greater than the length of the slot into which the hanger is to be received (whether that slot be upon a stud, slotted track, or another logistics bracket). In addition, the “height” of the web 15 (indicated by “b” in FIG. 14) is slightly less than the length or “height” of the slot into which hanger 7 is to be received. Further, the length of flange 14 is in this embodiment greater than that of flange 15.

It will thus be appreciated that such a configuration permits bracket 1 to be tilted in order for upper flange 14 to be received within the upper portion of the slot, to the point where the upper portion or surface of web 16 contacts the upper end of the slot. At that point, while maintaining contact between web 16 and the upper end of the slot, bracket 1 can be rotated to permit lower flange 15 to bypass the lower end of the slot and be received within the slot. Bracket 1 can be then further rotated to the point where front surface 3 of elongate body 2 is generally parallel to the wall of the trailer or containment vessel. At that point, releasing bracket 1 will cause the bracket to move downwardly until the lower surface of web 16 rests upon the lower end of the slot. Since upper flange 14 is longer than lower flange 15, both the upper and lower flanges will be received and engaged against rear surface 14 of elongate body 2, thereby securing bracket 1 in place and preventing it from being withdrawn without performing the above described movements in their reverse order. It will therefore be appreciated that the described structure presents a simple, fast and efficient method to secure bracket 1 in place within slots of a stud or slotted track without the use of hand tools or other securement devices. Similarly, the bracket can be easily removed and repositioned to other locations along the wall of the trailer or containment vessel, or removed for storage and future use.

In an embodiment of the invention, elongate body 2 includes one or more channels 17 that extend longitudinally along rear surface 4. Channels 17 serve the function of permitting one or more of hangers 7 to be slidably received therein so that the hanger can be secured to elongate body 2 while still permitting the position of the hanger to be adjusted along the length of the body.

In the case of the logistics bracket shown in the attached drawings, elongate body 2 includes an upper surface 18 and a lower surface 19, each of which extends rearwardly from rear surface 4 at an approximate right angle. In addition, each of upper and lower surfaces 18 and 19 contains an inwardly oriented longitudinal lip 20 that extends generally along the length of elongate body 2. Together, the respective upper and lower surfaces, their respective lips, and portions of rear surface 4 form upper and lower longitudinal channels 17 that extend along the length of elongate body 2. The configuration of these channels not only helps to provide strength and rigidity to the elongate body but also presents a means by which one or more hangers 7 can be slidably received within the body.

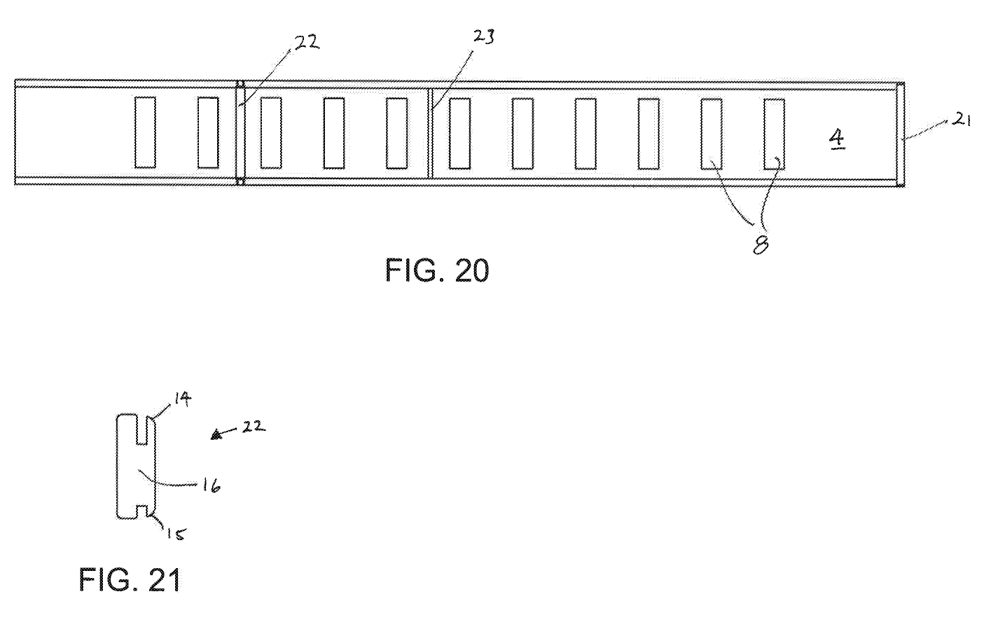

With reference to FIGS. 20 and 21, there is depicted an embodiment wherein logistics bracket 1 is designed for horizontal orientation with a fixed hanger 21 at one end and a slidable hanger 22 at an opposite end. As shown in FIG. 21, the plate 13 from which slidable hanger 22 is formed is of a configuration such that it is receivable within upper and lower channels 17, and retained in place by lips 22 (shown more particularly in FIG. 12). To enhance the rigidity of elongate body 22, where one or more slidable hangers are utilized the elongate body may also include one or more fixed bulkheads 23 that extends across rear surface 4 between upper surface 18 and lower surface 19. It should also be noted that although the particular embodiment shown in FIG. 21 comprises a logistics bracket having a fixed hanger 21 and a single sliding hanger 22, in alternate embodiments multiple fixed hangers and/or multiple sliding hangers may be incorporated into the same elongate body construction.

Where elongate body 2 is intended for vertical orientation, hangers 7 will extend outward from rear surface 4 such that their web portions 16 are generally parallel to the longitudinal axis of elongate body 2 (see FIGS. 22-26). Where the hangers are sliding hangers they will generally have plates 13 that extend perpendicular to the longitudinal axis of elongate body 2 and that are received within longitudinal channels 17 so that they can be slid along the length of the longitudinal body to a desired location. Web portions 16 of the hangers will extend outwardly at approximate right angles such that the webs and flanges are generally vertically oriented for receipt within generally vertically oriented slots (see particularly FIGS. 25 and 26). Otherwise, the function and operation of hangers utilized on an elongate body designed for vertical orientation are essentially the same as those in the case of elongate body designed for generally horizontal orientation.

It will thus be appreciated and understood that the unique combination of elements and features of logistics bracket 1 provides a mechanism for the fast and efficient securement of the bracket to studs, slotted track or other articles having slots within the walls of a trailer or containment vessel. The logistics brackets of the present invention may be designed for either horizontal or vertical application and contain slots 8 within their elongate bodies 2 that are generally the same size and configuration as the slots within the walls of the trailer or containment vessel to which they are secured. In that manner, the brackets form a universal assembly that permits a user to utilize various numbers of brackets in different vertical and/or horizontal orientations to very particularly locate a logistics bar at an optimum position, in both the vertical and horizontal planes, within the trailer or containment vessel. Whereas in the prior art, those transporting freight were limited to the placement of logistics bars at locations aligning specifically with the location of studs or slotted track within a trailer or containment vessel, through utilizing the logistics brackets of the present invention, one is able to “fine tune” the position of a logistics bar and is not limited to the pre-existing location of the slots in a stud or slotted track.

Further, in the embodiment where elongate body 2 includes a slidable hanger, there is presented the ability to accommodate studs, slotted tracks or other slots within a trailer or containment vessel of a non-traditional spacing. Incorporating one or more slidable hangers within elongate body 2 thereby further enhances the flexibility of a system designed using a plurality of logistics brackets, and enhances the ability to adapt those brackets to a wide variety of different trailer or containment vessel configurations.

The brackets of the current invention also permit the positioning of logistics bars in such a manner that freight can effectively be decked or stacked within a trailer or containment vessel while not making contact with freight below. That is, a series of logistics brackets can be positioned above freight within the trailer or containment vessel, permitting additional freight to be loaded above the existing freight to maximize the utilization of the available space within the trailer or containment vessel. Such an ability is particularly useful where loading additional freight directly on top of freight already present could cause damage to the freight at the bottom of the stack. The logistics brackets of the current invention provide the flexibility to locate the necessary number of logistics bars at positions that enable the “stacking” of freight in this manner.

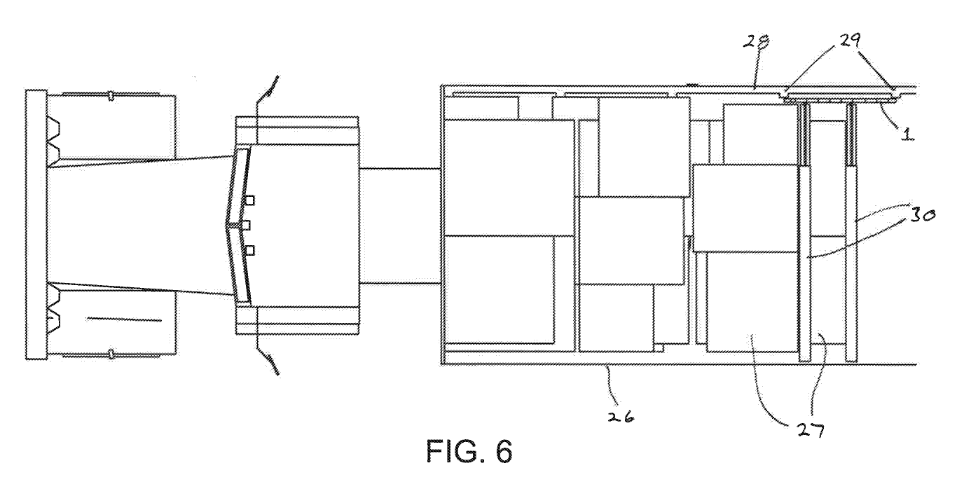

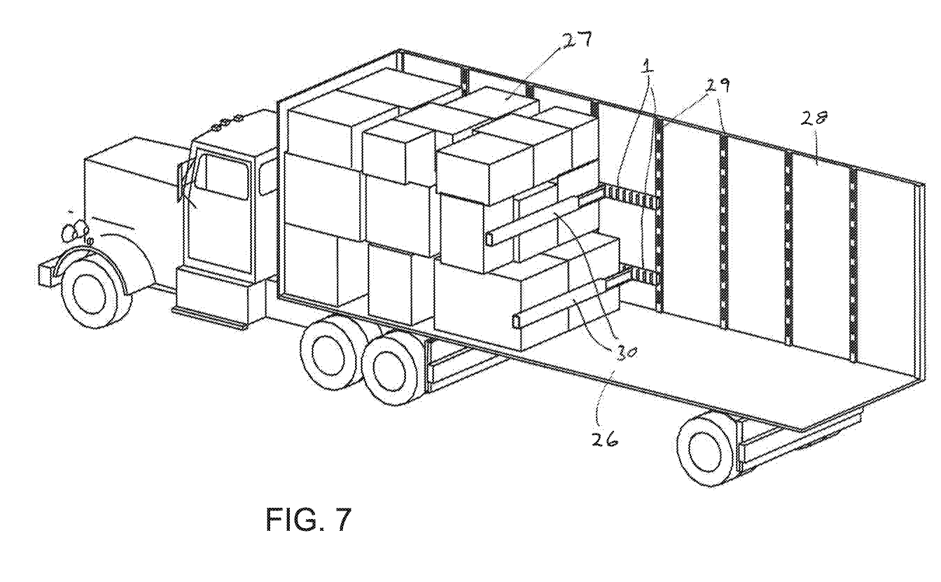

FIGS. 5 through 10 illustrate just some of the different configurations that are possible when utilizing logistics brackets in accordance with embodiments of the invention. In particular, FIGS. 5 and 6 show how two logistics bars can be placed at different elevations and at different positions along the length of the trailer to accommodate freight is not uniformly stacked, such positioning of the logistics bars to being possible through direct attachment of the logistic bars with the trailer studs.

It is to be understood that what has been described are the preferred embodiments of the invention. The scope of the claims should not be limited by the preferred embodiments set forth above, but should be given the broadest interpretation consistent with the description as a whole.

I claim:

1. A bracket for releasably securing a logistics bar within a trailer or containment vessel, the logistics bar helping to prevent shifting of freight during transport, the bracket comprising:
an elongate body having two or more hangers secured thereto, said hangers releasably securable to walls of the trailer or containment vessel to thereby hang said bracket from a wall of the trailer or containment vessel, said body having one or more slots therein, said slots releasably receiving an end of a logistics bar to permit the logistics bar to be releasably securable to said bracket, said bracket securable to said wall at different locations along the wall of the trailer or containment vessel thereby permitting the positioning of the logistics bar within the trailer or containment vessel at a desired location.

2. The bracket as claimed in claim 1 wherein said elongate body includes two hangers, fixed a pre-determined distance apart, said pre-determined distance approximating the centre-to-centre spacing of studs within the walls of the trailer or containment vessel.

3. The bracket as claimed in claim 2 wherein said hangers are fixed to said elongate body in a configuration where said hangers are generally parallel to said elongate body such that upon securement of said bracket to a wall of the trailer or containment vessel said bracket is in a generally vertical orientation.

4. The bracket as claimed in claim 2 wherein said hangers are fixed to said elongate body at approximate right angles such that when said bracket is releasably secured to a wall of the trailer or containment vessel said bracket is in a generally horizontal orientation.

5. The bracket as claimed in claim 4 wherein said hangers comprise plates extending outwardly from a rear surface of said elongate body, said plates having ends with flanges extending outwardly at approximate right angles, said flanges releasably receivable within slots within a wall of the trailer or containment vessel to releasably secure said bracket to said wall.

6. The bracket as claimed in claim 5 wherein one of said flanges is longer than the other.

7. The bracket as claimed in claim 6 wherein said elongate body includes an upper surface and a lower surface, said upper and lower surfaces extending rearwardly from the rear surface of said body, each of said upper and lower surfaces containing an inwardly oriented longitudinal lip extending along the length of said body, said lips, said respective upper and lower surfaces and said rear surface forming upper and lower longitudinal channels extending along the length of said elongate body, said upper and lower channels slidably receiving one or more of said hangers.

8. The bracket as claimed in claim 7 wherein said elongate body further includes at least one bulkhead extending between said upper and lower surfaces adjacent said rear surface.

9. The bracket as claimed in claim 2 wherein said elongate body includes one or more channels extending longitudinally along a rear surface of said body, at least one of said hangers slidably received within said one or more channels to secure said hanger to said body while permitting the position of said hanger to be adjusted along the length of said body.

10. A bracket for releasably securing a logistics bar within a trailer or containment vessel, the logistics bar helping to prevent shifting of freight during transport, the bracket comprising:
an elongate body having a front surface, a rear surface, an upper surface and a lower surface, said upper and lower surfaces extending rearwardly from said rear surface, each of said upper and lower surfaces having an inwardly oriented longitudinal lip extending substantially along the length of said elongate body, said lips, said respective upper and lower surfaces and said rear surface together forming upper and lower channels extending substantially along the length of said longitudinal body; and
two or more hangers secured to said elongate body, at least one of said hangers slidably received within said upper and said lower channels securing said at least one hanger to said elongate body while permitting the position of said at least one hanger to be adjusted along the length of said elongate body, said hangers releasably securable to walls of the trailer or containment vessel to thereby hang said bracket from a wall of the trailer or containment vessel, said body having one or more slots therein, said slots releasably receiving an end of a logistics bar to permit the logistics bar to be releasably securable to said bracket, said bracket securable to said wall at different locations along the wall of the trailer or containment vessel thereby permitting the positioning of the logistics bar within the trailer or containment vessel at a desired location.

11. The bracket as claimed in claim 10 wherein said elongate body further includes at least one bulkhead extending between said upper and lower surfaces adjacent said rear surface, said bulkhead enhancing the rigidity of said elongate body.

12. A system to assist in releasably securing a logistics bar within a trailer or containment vessel, the system comprising a plurality of the brackets of claim 1, wherein at least a first bracket is releasably securable to a wall of the trailer or containment vessel and at least a second bracket is releasably securable to an opposite wall of the trailer or containment vessel, thereby permitting one end of the logistics bar to be releasably secured to each of said brackets to releasably mount the logistics bar between the walls, and at a desired height and at a desired location along the length, of the trailer or containment vessel.

13. The system as claimed in claim 12 wherein said plurality of brackets include brackets having hangers oriented generally perpendicular to said elongate body to permit horizontal mounting of said brackets, said system further including brackets having hangers oriented generally parallel to said elongate body to permit the mounting of said brackets generally vertically.

14. The system as claimed in claim 13 wherein one or more of said brackets have at least one hanger slidably receivable within one or more channels along a rear surface of said bracket to permit an alteration of the spacing between the hangers on an individual bracket.

15. The system as claimed in claim 14 wherein said elongate body includes an upper surface and a lower surface, said upper and lower surfaces extending rearwardly from the rear surface of said body, each of said upper and lower surfaces containing an inwardly oriented longitudinal lip extending along at least a substantial portion of the length of said elongate body, said lips, said respective upper and lower surfaces and said rear surface forming an upper and a lower longitudinal channel extending along the length of said elongate body, said upper and lower channels slidably receiving one or more of said hangers.

16. The system as claimed in claim 15 wherein said bracket includes one hanger slidably received within said upper and lower longitudinal channels and one hanger fixed to an end of said rear surface of said longitudinal body.

17. The system as claimed in claim 16 wherein said elongate body further includes at least one bulkhead extending between said upper and lower surfaces and adjacent said rear surface, said bulkhead enhancing the rigidity of said elongate body.
